(19) United States
(12) Patent Application Publication
(10) Pub. No.: US 2025/0156201 A1
(43) Pub. Date: May 15, 2025

(54) LOCAL INTERFACE MANAGEMENT FOR MULTIPARTY DATA PROCESSING PIPELINES

(71) Applicants: Chris Mace, Salt Lake City, UT (US); Derik Anderson, South Jordan, UT (US)

(72) Inventors: Chris Mace, Salt Lake City, UT (US); Derik Anderson, South Jordan, UT (US)

(21) Appl. No.: 18/943,705

(22) Filed: Nov. 11, 2024

Related U.S. Application Data
(60) Provisional application No. 63/548,362, filed on Nov. 13, 2023.

(51) Int. Cl. G06F 9/451; G06F 3/04845

(52) U.S. Cl. CPC G06F 9/451; G06F 3/04845

(57) ABSTRACT

A client device instantiates a local interface management instance configured to modify a user interface of a frontend application of a third-party platform in order to emphasize specific affordances of the frontend application.

### RELATED APPLICATION

This application is a nonprovisional of, and claims the benefit under 35 U.S.C. § 119 of, U.S. Provisional Patent Application No. 63/548,362, filed on Nov. 13, 2023, and entitled “Local Interface Management for Multiparty Data Processing Pipelines” the contents of which is incorporated by reference in its entirety.

### TECHNICAL FIELD

Embodiments described herein relate to data input systems and, in particular, to systems and methods for command and control of local frontend interfaces of third-party controlled data input systems.

### BACKGROUND

An organization may provide its employees with access to one or more software tools to facilitate collaboration and completion of work. Typically, an organization licenses access to such software tools, for each employee, from one or more third-party software providers or vendors. Some third-party software tools may be used by an employee of the organization to enter data into a proprietary system managed and controlled by a third-party. In some cases, the third-party system may be a required intermediary to provide and/or format the employee's input data to input another third-party system, such as a government data collection system, a standards body data collection system, an application clearinghouse, and the like.

However, many data entry systems provided by third parties intentionally design frontend user interfaces for general purposes, and are not optimized to improve efficiency of any particular organization's or employee's use case.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a multiparty data processing pipeline, such as described herein.

FIG. 2 depicts a system diagram of a portion of a multiparty data processing pipeline including a client device executing an instance of a local interface management service, as described herein.

FIG. 3A depicts an example frontend application interface of a third-party software platform.

FIG. 3B depicts an example user interface of a third-party software platform frontend instance operating in conjunction with a local interface management service as described herein.

FIG. 3C depicts an example user interface of a third-party software platform frontend instance operating in conjunction with a local interface management service as described herein.

FIG. 4 depicts an example user interface of a third-party data input application instance operating in conjunction with a local interface management service as described herein in which the local interface management service configuration is stored by the third-party data input application itself.

FIG. 5 is a flowchart depicting example operations of a method of operating a local interface management service as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to computing systems, computer architectures, and computer-implemented methods configured to provide, control, and manage access to user interfaces rendered by frontends of third-party software tools. More specifically, a system described herein provides for customized management of local frontend user interfaces associated with third-party data entry platforms that are configured to (1) collect user input, (2) format and organize that input according to a defined schema or format, and (3) to provide the formatted user input to a data collection entity as input. Examples of data collection entities include government bodies, standards organizations, industry-specific organizations, and the like.

For example, a healthcare provider may be required to use a particular third-party software platform to report certain community health information to a government body (e.g., number of COVID infections, as an example). In another example, a grant-funded organization may be required to use a particular third-party software platform to report metrics to an administrative body responsible for issuing the grant. In another example, an underwriter may be required (by law or by effective monopoly) to use a particular third-party platform to enter applicant information into a uniform application format distributed to an application clearinghouse, one or more carrier API endpoints, and/or to one or more application reviewing bodies.

Generally and broadly, embodiments described herein relate to data entry and/or collection paradigms in which raw data is input by a first party, structured or formatted by a second party, and received in a structured format by a third party. As may be appreciated by a person of skill in the art, the second party serves as a chokepoint; efficiency of data entry by the first party is nearly entirely controlled by and/or informed by design decisions of the second party.

For example, the second party may design a data entry platform for general purposes-intended for use by many different first parties in many different industries and/or for many different use cases. As a result of this design choice, a particular first party may be presented with a general purpose user interface with dozens of fields that are not required for the first party's use case. As a result of this unnecessary rendering of fields, the first party is required to diligently search through the user interface for required fields, and must be trained on which fields are ignorable and which are required.

As an example, the first party may be a healthcare provider obligated to report certain infection rates to a local authority. To make such reports, the healthcare provider is required to use a data entry platform contracting with the local authority. The local authority thereby receives structured data in a uniform format so that analysis and reporting by the local authority is simplified. However, the data entry platform in this example may provide a form used to collect data in respect of multiple different infection types and/or reportable to multiple different organizations. As a result, an employee of the healthcare provider tasked with making reports in respect of a specific infection type is required to be trained on the data entry platform and/or is required to gain experience with the data entry platform by trial and error. This experience and/or training can equip the employee with the requisite knowledge to understand the location within the graphical user interface of the data entry platform of required affordances, what errors or warnings raised by the data entry platform can be ignored and which need to be acted upon, and so on. Once this knowledge is gained, the employee in many circumstances will be required to document that knowledge by creating training materials for other employees of the healthcare provider. As understood by a person of skill in the art, the time required to generate comprehensive training materials in respect of a single task against a single software tool is often not insignificant.

Problematically, if the data entry platform pushes an update or otherwise changes its user interface, the training materials previously generated become stale. Unless training materials are promptly updated, out-of-date training materials may exacerbate the time required to train new employees. More simply, new employees training on old materials may waste significant time learning out-of-date practices, time that might have better been spent learning the updated data entry platform from scratch.

A person of skill in the art can readily appreciate that (1) the time required to understand a generically-designed user interface layout, (2) the time required to document and prepare training materials memorializing that knowledge, and (3) the time required to update training materials periodically are all compounding and borne exclusively by the first party. Further, these inefficiencies are entirely dependent on the design decisions of the second party and the solvency and product offerings decisions of the second. For example, if the second party sunsets, deprecates, or discontinues the data entry platform, training materials, developed expertise, and time associated each therewith become valueless, potentially resulting in an employee's position being eliminated.

Further still, the entire multiparty data processing pipeline is limited by throughput of the second party. More specifically, the third party does not receive and cannot act upon information entered by the first party (however efficiently) until the second party's system is fully and properly populated.

These foregoing described inefficiencies compound and scale, resulting is significant waste of data entry time substantially borne by the first party.

In another example, the first party may be a mortgage broker, the second party may be mortgage origination platform, and the third party may be one or more lenders or underwriters. In this example, the broker is tasked with entering applicant information into a frontend user interface of the mortgage origination platform before a uniformly-formatted application can be output by the origination software and provided to one or more lenders as structured data. In these examples, the foregoing described inefficiencies may result in lower closing volume for the broker and a significant investment in training each broker associate, simply due to the time commitment required to enter data in multiple locations and/or verify that application-specific data items are all entered properly.

In another example, the first party may be a nonprofit organization required by one or more grant-issuing organization to submit reports via a data entry contractor to a central repository. As with preceding examples, training burdens on employees of the nonprofit in respect of the use of the data entry contractor's system can result in a lower program efficiency ratio for the nonprofit, which in turn can effect further contributions and fundraising efforts.

In another example, an accountant office may be required to enter time into a time entry system provided by a third party. The time entry system provides structured output to an invoicing system, in turn configured to generate and circulate time-based invoices to clients of the accounting firm. The time entry system may include options and/or input fields not required by the accounting firm and/or not required of all accounting projects. Nevertheless, each accountant or timekeeper of the accountant firm is required to train against the time entry system and to learn which affordances are required, which can be ignored, and so on.

In a similar example, a law office may be required to enter time into a time entry system provided by the same third party. As with the example accountant office, the time entry system provides structured output to an invoicing system, in turn configured to generate and circulate time-based invoices to clients of the law office. The time entry system may include options and/or input fields not required by the law office and/or not required of all accounting projects. Nevertheless, each lawyer or timekeeper of the law office is required to train against the time entry system and to learn which affordances are required, which can be ignored, and so on.

These foregoing examples are not exhaustive of multiparty data entry pipelines that introduce purpose-specific inefficiencies for individual clients or users of those systems. As such, for simplicity of description, the embodiments that follow reference a “structured data collection entity” (the third party of the preceding examples) that receives structured input generated by a “third-party software platform” (the second party of preceding examples) that in turn generates a user interface to receive manual data input from a user (the first party of the preceding examples). It is appreciated, however, that many software tools and many data intake organizations, bodies, and entities are contemplated herein.

In particular, systems and methods described herein relate to interoperating software instances executing on a client device of a user.

Specifically, a client device may be a laptop computing device or a desktop computing device including a processor, a memory, networking capabilities, and a display. The memory can include a working portion and a storage portion. The processor can be configured to access from the storage portion one or more executable instructions or assets that, when loaded into the working portion cause the processor and the memory to cooperatively instantiate a software application (a “frontend application instance”) developed, distributed, and maintained by a third-party software platform. The user may provide credentials to the third-party software platform for authentication purposes, but this is not required of all embodiments.

The frontend application instance can be configured to render a graphical user interface with the display of the client device. The graphical user interface can include one or more affordances with which a user of the client device can provide input. The affordances may be editable text fields, radio buttons, checkboxes, and the like. The graphical user interface can additionally include sections to display document data, long-form text, image data, and so on. The graphical user interface may also include one or more affordances to facilitate uploading of documents and the like.

In general, the frontend application instance also leverage networking capability of the client device to communicably couple to a backend application instance of the third-party software platform. The backend application instance can likewise be instantiated over one or more computing resources, including one or more processors and memory devices which may be co-located or geographically distributed and allocated to the backend application instance by operation of one or more of a hypervisor, orchestrator, container provisioner, or any other suitable virtualization or resource aggregation and distribution system.

The frontend application can submit requests to the backend application instance via any suitable networking or communications protocol. As an example, TCP communications may be used in many examples. Communications between the frontend application and the backend application may be, and often are, encrypted such that no exfiltration or capture of confidential information input to the frontend is possible.

The backend application can be configured to process data input to the frontend application and provide, as output, a uniform structured data object or file that can in turn be provided as input to one or more structured data collection entities or software platforms.

For embodiments described herein, the client device instantiates a second instance of software in addition to the frontend application instance. For embodiments described herein, the second application instance can be referred to as a local interface management service. The local interface management service is configured to load from a memory or data store accessible to the client device and/or the frontend application instance one or more configuration objects specific to the user's use case in respect of the third-party software platform.

The configuration objects can define an association between (1) a particular identifier of an affordance rendered in the graphical user interface of the frontend application instance and (2) at least one validation rules, decoration rules, notification rules, sound alert rules, and so on. In addition, the configuration objects can each define a hook and a callback associated with the respective affordance. The hook may be a user input event, notification event, or other cross application event generated by the first application instance. The callback can be a function or method identifier or pointer associated with the local interface management service. The callback can be associated with the hook such that when the hook event occurs, the callback is executed with or without one or more arguments.

When the callback is executed, the local interface management service can be configured to access one or more rules defined by and/or referenced by the configuration object associated with the callback. These rules can consume, as input, a current value provided as input to an affordance identified by the hook event. The rules can be evaluated against the current value(s) and results of those evaluations can trigger one or more actions in response. An action may be a custom decoration of the associated affordance (e.g., changing a border color, changing underline, adding an animation, changing a font, and so on), an acoustic or haptic feedback, a notification via a communication channel (e.g., messaging platform, SMS message, email message, and so on). For simplicity of description, the embodiments that follow reference an example custom decoration of an affordance as an action taken in response to a hook event, but it may be appreciated that this is a single example.

In addition, for simplicity, the embodiments that follow reference an example rule as an input data validation by format rule, determining whether an input to a text input box complies with a particular format definition. As an example, an email address may be required to include only alphanumeric characters at least one period and at least one commercial at mark (e.g., “@”). In these examples, the rule passes when text provided as input to the rule contains a valid string of alphanumeric characters with at least one period and at least one commercial at. The rule fails (returns a boolean false as one example) when input text includes at least one nonalphanumeric character or does not include both a period and a commercial at mark.

In view of the foregoing, an example embodiment described herein includes a frontend application instance with at least one text input box identified by an identifier. The local interface management service can access from memory one or more configuration objects based on the identifier. For example, the memory can store configuration objects by reference number and/or by reference to a lookup table associating a location in memory with the identifier of the at least one input box. Once an appropriate configuration object is obtained, the local interface management service can attach to or otherwise subscribe to events generated in respect of a hook that fires one or more events based on user interactions with the text input box. Example events include, but are not limited to: selection of the text input box; de-selection of the text input box; focus to the text input box; focus away from the text input box; text changed within the text input box; text removed from the text input box; and so on.

Each of these events can be associated with a single hook to the text input box, or in some cases, may be associated with individual hook services or event sources.

The local interface management service also communicably couples a recipient endpoint that receives hook events to a callback function likewise defined by the configuration object selected based on the identifier of the text input box. In this manner, when an event is fired by the frontend application instance, the callback function is called. In many examples, the callback is called with one or more arguments, including but not limited to: the identifier of the text input box; a location of the text input box within the graphical user interface (either relative or absolute); a location of the text input box within the display (either relative or absolute); and/or text content of the text input box. For simplicity of description, many embodiments that follow reference an event fired when content within the text input box changes (e.g., a user types additional characters or deletes existing characters), but it is appreciated that this is merely one example.

In further view of the foregoing, an example embodiment described herein includes a frontend application instance with a text input box identified by an identifier. The local interface management service can access from memory a configuration object based on the identifier. The configuration object, when executed by the local interface management service, subscribes to a hook event fired whenever text content of the text input box changes. In response to each content change event, a callback again identified or defined by the configuration object is called. On each call, the local interface management service is configured to validate the content of the text input box against an email format rule. If the rule fails, a first decoration can be rendered in a UI layer above the graphical user interface of the frontend application. For example, the first decoration may be a red border encompassing a perimeter of the text input box. Alternatively, if the rule passes, a second decoration (optionally) can be rendered in the UI layer above the frontend application that communicates passage of the rule-for example, a green checkbox can be rendered over the text input box so that it may appear to a user that a green checkbox has been rendered by the frontend application itself.

A custom decoration, such as described above, may be rendered in the graphical user interface by the local interface management service over the frontend application. More specifically, a custom decoration may be rendered in a user interface layer above the frontend application so as to emphasize the affordance. For example, if an affordance identified in a particular hook event is placed at a screen location relative to an upper left corner of the display of the client device at w=100, h=200, the local interface management service can render a custom user interface element over the frontend at position w=95, h=195. The custom element may be a brightly colored sprite, such as a star shape filled red. As a result of the operation of both application instances, a change to the content of the affordance can result in rendering of a red star in the upper left corner of that affordance. In other cases, the custom element rendered by the local interface management service over the frontend application can be, without limitation: a border encompassing the affordance; an underline of the affordance; an animation of a sprite around the affordance; a zoomed-in or otherwise scaled reproduction of the affordance; a rotated or mirrored reproduction of the affordance; a reproduction of the affordance with a color replaced with another color; an animated reproduction of the affordance; dimming or obscuring or blurring a particular affordance (e.g., an affordance not used); dimming or obscuring all but one affordance; and so on.

This architecture permits an organization to design a set of configuration objects keyed to user interface element identifiers important to the organization. Each of the configuration objects can define any number of UI decorations that emphasize an affordance or a portion thereof (e.g., a text location within a text box). The configuration objects can likewise define any number of UI decorations to other affordances separate from the identified affordance. For example, a UI layer that masks substantially all affordances apart from the identified affordance may be used in some embodiments.

In some examples, arrows specifically highlighting specific affordances can be rendered. In other cases, different configuration objects can be linked together in a linked list or other manner such that once a rule associated with a first affordance passes, a second affordance is automatically emphasized, for example by rendering a large, attention-capturing arrow alongside the “next” input box as defined by the organization's suite of configuration objects.

In this manner, an organization can set up a preferred order in which a user should enter data into a form or graphical user interface page of the frontend application. In this way, a collection of configuration objects can guide even the most novice user through a data entry task from field to field, validating each field along the way. In some cases, configuration objects and associated functions and rule sets can be selected based on the user or based on the user's role in an organization (e.g., by querying a corporate directory or other directory service). More specifically, an expert loan officer may receive different cues or emphasis (via decoration of the frontend application) than a novice officer. More simply, different configuration objects and/or different rulesets can be applied in different contexts.

In this manner, the organization's suite of configuration objects follow user interface identifiers, and not a particular interface layout of a particular version of the third-party software. As a result, whenever third-party software changes a user interface layout, or changes pagination of user interfaces, or changes the order in which sections of a UI are shown, emphasis and validation provided by the organization follows new locations of those affordances automatically.

Further still, different interface layouts that identify affordances in the same manner can be handled in the same manner per an organization's suite of configuration objects. For example, a third-party software platform can include an affordance identified as “applicant_first_name” on multiple pages. For embodiments described herein, the local interface management service can apply identical validation rules, decorations, and other actions to each occurrence or rendering of the same affordance.

Further to the foregoing, linked or associated configuration objects can be used to populate additional field or provide data to other affordances. For example, entering data into a field identified as “applicant_first_name” can cause to be automatically populated every similarly-named field in the frontend application. In addition, a field named “applicant_full_name” can be automatically populated by concatenating the content of “applicant_first_name” and “applicant_middle_name” and “applicant_last_name.” In this manner, input to one field may result in the automatic population of multiple fields within a presently-rendered portion of the graphical user interface or, in some examples, in later-rendered portions of the graphical user interface (e.g., the local interface management service can store values of each field and use those stored values to populate later-rendered fields as appropriate).

In some embodiments, a local interface management service can be configured to render UI decorations within the frontend application interface itself. For example, the local interface management service can be configured to leverage a graphics library (or other UI rendering framework, library, or engine) used by the frontend application instance to cause the frontend application instance to modify its own user interface elements by changing background colors, font colors, border colors, border thickness, and so on. In some cases, the local interface management service can be configured to render an overlay UI (as described above) in addition to causing the frontend application instance to render its own elements differently from default, based on the configuration objects.

In some embodiments, a local interface management service can be configured to leverage the frontend application itself for storage of configuration objects. For example, in some cases, the local interface management service can be configured to store a structured data object defining the configuration object in plain text in a text filed of the frontend application (e.g., a notes field).

In some embodiments, the local interface management service can be configured to operate as a plugin or framework that is instantiated automatically at runtime with the frontend application instance. In other cases, the local interface management system is separately instantiated.

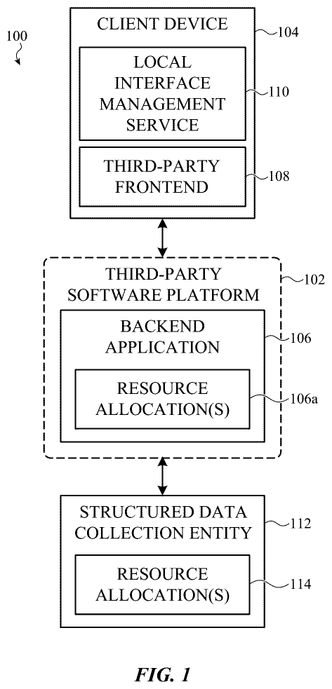

These foregoing and other embodiments are discussed below with reference to FIGS. 1-5. However, those skilled in the art will readily appreciate that the detailed description given herein with respect to these figures is for explanation only and should not be construed as limiting.

FIG. 1 depicts a multiparty data processing pipeline, such as described herein. the multiparty data processing pipeline 100 includes three parties necessary to complete an action.

In particular, a first party inputs data to a second party's data entry system which in turn is configured to format and/or structure data to be receive and acted upon by a third party. As with other embodiments described herein, the three parties are referred to as a user (first party), a third-party software platform (second party), and a structured data collection entity (third party). In many examples, the user provides data input to the third-party software platform which, in turn, provides structured output to be received by the structured data collection entity.

An example of a multiparty data processing pipeline may an accountant (user) entering time into a general-purpose time capture system (third-party software platform) that is configured to provide machine readable structured output to an invoicing system (structured data collection entity). In this example, the general-purpose time capture system may provide options and/or affordances that are not used by the invoicing system, but are nevertheless required by the general-purpose time capture system. As a result, the accountant may be required to enter unnecessary data into the general-purpose time capture system (to satisfy its internal data validation configurations or schemas). In other cases, the accountant may be required to enter data redundantly, in multiple fields. In still further examples, a field required by the invoicing system may not be expressly required by the general-purpose time entry system. In this example, the accountant's data entry may be accepted by the time entry system, but will be rejected by the invoicing system. In yet other examples, data validation rules of the invoicing system may differ from data validation rules of the time entry system. In this manner, data judged as valid by the time entry system may be rejected by the invoicing system. For example, in some cases, the invoicing system may require a particular text field to be entered in ALL CAPS, whereas the time entry system has no such requirement. In this example, the accountant may enter “data” into the field, which is accepted by the time entry system. The time entry system output, however, will be rejected by the invoicing system, which expects “DATA” in ALL CAPS.

In view of the foregoing, it may be appreciated that generally and broadly, when multiple parties are involved in a data processing pipeline, different and/or unidentical requirements for fields and format and validation of each party can lead to inefficiencies including redundant data entry, insufficient data entry, improperly-formatted data, or unnecessary data entry.

Continuing the previous example, the invoicing system used by the accountant may require a special task code for certain invoice line items. The general-purpose time entry platform may support the option for special task codes, but may not require task codes before indicating to the accountant that a time entry is complete. As a result, the accountant may inadvertently overlook entering a task code in the time entry system, causing a process breakdown once the time entry system submits structured data to the invoicing system. In this example, the accountant wastes time by not providing sufficient data to the time entry system because the requirements of the time entry system and the invoicing system are not identical.

In other cases, the time entry system may be configured by default to require decimal precision to 0.1 hour intervals for each time entry. In some cases, the accountant may be performing a fixed-fee billable item for which the invoicing system does not require time to be entered. In this case, the accountant may be required by the time entry system to input a time value despite that the invoicing system does not require populating of that field. In this example, the accountant wastes time by being required to enter unnecessary data into to the time entry system because, again, the requirements of the time entry system and the invoicing system are not identical.

Further still, the time entry system may include multiple fields in which the accountant is required to enter a client code. In this example, the accountant wastes time by entering redundant data.

Further still, the time entry system may not require particular validation of an email address field whereas the invoicing system requires data within the corresponding field to follow a rigid format. In other cases, the time entry system may not require a client ID to follow any particular format, whereas the invoicing system expressly requires only a 6-digit number. In either case, the accountant's input is received as valid by the time entry system, but is rejected by the invoicing system.

In another example, an attorney may use a different invoicing system (with different requirements from the accountant's invoicing system) but may still use the same general-purpose time entry platform. The attorney's use cases and requirements, and the attorney's invoicing system's requirements may differ from the general purpose time entry system in different ways than the accountant but nevertheless the attorney may likewise waste time providing redundant data, insufficient data, or unnecessary data input to the time entry system.

Another example of a multiparty data processing pipeline may a mortgage broker (user) entering applicant information into a loan origination platform (third-party software platform) that is configured to provide machine readable structured output to one or more underwriting APIs (structured data collection entity). In this example, the loan origination platform may provide options and/or affordances that are not used by one or more of the underwriting APIs, but are nevertheless required by the loan origination platform. In other cases, the mortgage broker may be required to enter data redundantly in multiple fields across different applications or sections of the same application for the same applicant. In still further examples, a field required by the one or more underwriting APIs may not be required by the loan origination platform. In this example, the mortgage broker's data entry may be accepted by the origination platform, but will be rejected by the one or more underwriting APIs. Each of these inefficiencies result from different requirements of the underwriting APIs and the loan origination platform. These inefficiencies compound to several negative effects. For example, inefficiencies reduce closing throughput thereby increasing closing costs (as a result of increased time required by the broker on a per-loan basis). In addition, as per-application time requirements increase, a broker can only identify a limited set of the full number of loan packages for which a particular applicant may qualify, thereby reducing the likelihood that any given applicant receives an ideal loan for that applicant's requirements. This negative effect increases risk to the mortgage broker, as a greater proportion of clients thereof may become over time dissatisfied with suboptimal mortgage product recommendations.

Another example of a multiparty data processing pipeline may be an executive director of a nonprofit (user) entering expense information into a data collection portal (third-party software platform) required by a government body for nonprofit transparency or another public policy purpose. As with other embodiments, the data collection portal is configured to provide machine readable structured output to one or more government bodies (structured data collection entity). As with other examples, the data collection portal may provide options and/or affordances that are not used by one or more of the government bodies, but are nevertheless required by the data collection portal. In other cases, the executive director may be required to enter data redundantly in multiple fields across different applications or sections of the same application for the same applicant. In still further examples, a field required by the one or more government bodies may not be required by the data collection portal. In this example, the executive director's data entry may be accepted by the origination platform, but will be rejected by the one or more government bodies. Each of these inefficiencies result from different requirements of the government bodies and the data collection portal.

To account for these and other inefficiencies, the embodiments described herein relate to systems and methods—referred to herein as a local interface management service—for effectively synchronizing field validation and field requirements across multiple platforms, automatically entering nonce data on behalf of a user for a non-required field, and automatically entering repeated data in redundant fields. In still further examples embodiments described herein are configured to provide guided emphasis to a user by manipulating and/or masking a frontend user interface of a third-party product so as to encourage the user to enter data in particular fields, in a particular order, and/or with particular formats. In this manner, requirements of the structured data collection entity can be enforced or encouraged at the first pipeline step, while the user is entering data in the first instance to the third-party software platform.

The multiparty data processing pipeline 100 depicted in FIG. 1 includes three parties, as with other embodiments. In particular, the multiparty data processing pipeline 100 includes a third-party software platform 102 communicably coupled to a client device 104 that may be operated by a user. The user operates a graphical user interface of the client device 104 to provide data input to a frontend application instance communicably coupled to a backend application instance collectively defining the third-party software platform 102.

The client device 104 can be any suitable electronic device. Examples include but are not limited to laptop computers, desktop computers, workstations, tablet devices, smart phones, and the like. This list is not exhaustive.

In typical embodiments, as noted above, a user of the client device 104 may be an employee of an organization. The organization is one that may from time to time submit information to one or more entities, such as government bodies, underwriters, administrative agencies, other software platforms and the like. For example, an organization may be required to submit periodic reports in a particular form or format to a particular agency or organization. In other cases, the organization may be required to submit a request or application in a particular form or format to an agency or other data collection/review entity.

In such circumstances, it may often be the case that the organization is required to provide data input to a third-party platform, in lieu of providing direct input to the final, ultimate, data collection entity or platform. In some cases, the organization may be required by law to leverage an intermediate third party, in other cases, an intermediate third party may enjoy a market monopoly, effectively requiring the organization to engage the third party in order to submit information as required.

Independent of the reason for which an organization may be required to pass information through one party in order to submit it to another party, this information flow paradigm can be referred to herein as a “multiparty” data processing pipeline.

In many cases, a multiparty data processing pipeline such as the multiparty data processing pipeline 100 includes at least three parties exchanging data. A first party, the user, provides input to the client device 104. The client device 104, in turn, provides input to a second party. In the illustrated embodiment, the second party is shown as the third-party software platform 102. Finally, once the third-party software platform 102 receives input from the user via the client device 104, the third-party software platform 102 may provide as output structured data to an appropriate structured data collection entity.

To receive data from the client device 104, the third-party software platform 102 includes a backend application instance 106 that is communicably coupled to a frontend application instance 108 executing on the client device 104.

As noted above, the backend application instance 106 can be instantiated by operation of computing resources of one or more datacenters, server systems, or the like. Generally and broadly, the backend application instance 106 may be instantiated by cooperation of a processor and memory and/or virtual instances consisting of time or core shares of physical processor and memory of one or more servers. The processor may load one or more executable assets from the memory to instantiate the backend application instance 106. Collectively, resources that cooperate to define operation of the backend application instance 106 are represented in FIG. 1 as the resource allocation 106a. The resources defining the backend application instance 106 may be co-located, or may be geographically distributed.

The backend application instance 106 can be configured for a variety of purposes. As noted above, the backend application instance 106 may be configured for collecting data from a user of the client device 104 so as to generate as output a structured document that can be provided as input to another system or a set of systems. Example purposes for which the backend application instance 106 may be configured include, but are not limited to: loan origination software; format standardization for government reporting; format standardization for compliance purposes; time entry or other work tracking and invoicing; and the like.

The backend application instance 106 is communicably coupled with the frontend application instance 108. As with the backend application instance 106 the frontend application instance 108 can be instantiated by cooperation of a processor and memory of the client device 104. Specifically, the processor can be configured to access form the memory one or more executable instructions or assets and load the retrieved assets into working memory so as to instantiate the frontend application instance 108.

As noted above, the processor and memory of the client device 104 can likewise be leveraged to instantiate an instance of a local interface management service 110. The local interface management service 110 can be instantiated in response to instantiation of the frontend application instance 108, or may be launched separately. In some cases, the user may instantiate the local interface management service 110 whereas in others, the frontend application instance 108 may be instantiated on a schedule, automatically on boot of the client device 104 or at another time. In some cases, the local interface management service 110 may be implement as a plugin or framework loaded into memory of the client device 104 by the frontend application instance 108 itself. Many methods are possible.

As noted above, the local interface management service 110 can be configured to modify a user interface rendered by the frontend application instance 108 in response to a configuration set by the organization employing the user of the client device 104. Generally and broadly, the local interface management service 110 can be configured to subscribe to one or more hooks or event feeds output by the frontend application instance 108 in respect of user interactions with one or more affordances rendered in a graphical user interface thereof.

More simply, each time a user interacts with the graphical user interface of the frontend application instance 108, the frontend application instance 108 can fire an event that can be received by the local interface management service 110, which in turn can act on that event via a registered callback. The registered callback, as noted above, can perform one or more functions or actions based at least in part on a configuration object associated with an affordance.

For example, the third-party software platform 102 may render a graphical user interface in the frontend application instance 108 that includes a field to receive a user's first name. In this example, as the user operates the client device 104 to type into the field, the field can fire one or more events. For example, an event can be fired when the user placed the cursor within the field (e.g., the field selected), when the user cause the field to become focused (e.g., tabbing into the field and/or selecting the field), in response to each character being typed by the user, in response to no new character being received for a timeout period (e.g., an input complete trigger), whenever the user clicks out of and/or otherwise defocuses the field, whenever the user hovers the cursor over the field prior to causing focus to change, and so on.

Each of these user input events can trigger different actions and/or may be associated with different configuration objects that can cause one or more registered callbacks to perform different functions. As noted above, some configuration objects can cause the local interface management service 110 to render a masking UI layer of the graphical user interface layer to visually emphasize one or more input boxes or affordances. In other cases, the local interface management service 110 can hook into the frontend application instance 108 itself to cause the frontend application instance 108 to render one or more affordances differently, for example causing the frontend application instance 108 to render a bold border around a particular element, element group, or set of interrelated elements.

In other cases, a configuration object and/or registered callback can be configured to perform functions outside of the scope of the third-party software platform 102. For example, certain callbacks can be leveraged to interact with an issue tracking system, project management system, or the like to automatically track tasks performed by the user when operating the client device 104. In other cases, a callback can be configured to initiate a notification via a notification channel, such as sending an email or message via a chosen platform. For example, a mortgage broker using a local interface management service 110 as described herein may configure the system to automatically notify an applicant that the broker is N % complete with filling out a particular application on behalf of the applicant. These examples are not exhaustive; many constructions are possible.

Generally and broadly, the local interface management service 110 is configured to access from a datastore one or more configuration objects that associate different functions, operations and actions with particular inputs provided by a user to the frontend application instance 108 of the third-party software platform 102. Example actions include applying custom validation rules to data input by the user, inserting input to other non-focused fields (e.g., to prevent the user from having to enter data multiple times), inserting nonce input into fields required by the third-party software platform 102 that are not required by other platforms, and so on.

The configuration objects can be interrelated and/or cross-referencing such that user interface masking and decoration can effectively guide the user from one field to a next field. In some cases, the local interface management service 110 can override the tab/selection order of fields such that configuration objects define what order particular fields should be populated by the user.

In this manner, an organization can construct a set of configuration objects that guide new and experienced users alike through a standardized data entry process via the frontend application instance 108. As a result of this construction that leverages identifiers associated with affordances in third party graphical user interfaces, layout of the third-party user interface is immaterial.

Once data entry has been completed by the user of the client device 104, the third-party software platform 102 and in particular the backend application instance 106 can be configured to generate a structured data object and to transmit that object to a structured data collection entity 112, which may be a separate instance of software (e.g., a backend application instance) executing on separate computing resources, such as the resource allocation 114.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

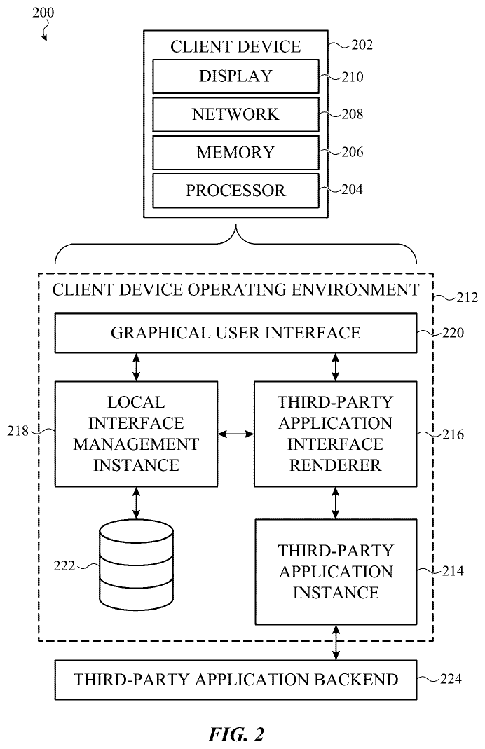

For example, FIG. 2 depicts a system diagram of a portion of a multiparty data processing pipeline including a client device executing an instance of a local interface management service, as described herein. The multiparty data processing pipeline portion 200 includes a client device 202. The client device 202 can be used and operated by a user, who may be an employee of an organization.

The client device 202 includes a processor 204, a memory 206, a networking module 208, and a display 210. Each of these components can be disposed within a housing configured to enclose and support components of the client device 202.

The processor 204 and the memory 206 can cooperate to instantiate a client device operating environment 212, which may be an operating system or similar software abstraction layer. Over the client device operating environment 212, one or more functional elements can be instantiated that facilitate exchange of information between the client device 202 and a user thereof. For example, the processor 204 and the memory 206 can cooperate to instantiate a third-party application instance 214. The third-party application instance 214 can include a graphics renderer or other framework, identified as the third-party application interface renderer 216, configured to render a user interface with which the user of the client device 202 can interact. The user interface can be rendered over the display 210.

The processor 204 and the memory 206 can likewise be configured to instantiate a local interface management service instance 218 configured to communicably couple to the third-party application instance 214 and/or the third-party application interface renderer 216. In some cases, the third-party application interface renderer 216 can be configured to generate and/or distribute one or more notifications/hook events to the local interface management service instance 218, such as described above. The local interface management service instance 218 can subscribe to these notifications and perform functions and actions, such as injecting a user interface decoration custom to a particular user interaction event or rendering a masking layer over the user interface associated with the third-party application interface renderer 216.

More specifically, the local interface management service instance 218 can be configured to modify a graphical user interface 220 of the client device operating environment 212 by rendering a layer over a user interface rendered by the third-party application interface renderer 216. In other cases, the local interface management service instance 218 can be configured to override a function of and/or inject one or more instructions into the third-party application interface renderer 216 to cause the third-party application interface renderer 216 to render its user interface within the graphical user interface 220 in a different than default manner.

The local interface management service instance 218 can determine what action(s) to perform given a particular input event provided to a particular affordance identified by a particular identifier. Each association between a particular action and a particular affordance can be stored in a configuration object stored in a data store 222. The data store 222 can be a database, or a portion of the memory 206. In other cases, the data store 222 can be a portion of program memory of the third-party application instance 214; many constructions are possible.

In many cases, the configuration objects sorted by the data store 222 take the form of XML or JSON formatted strings representing structured data defining actions and affordance and/or actions. A person of skill in the art appreciates that these are merely examples; configuration objects can be stored and formatted in a number of ways.

In this manner, a set of configuration objects define how data should be entered into the third-party application instance 214. The configuration objects can enforce validation rules of downstream systems, can cause to be inserted nonce data into fields irrelevant to downstream systems, enforce custom validation rules preferred by an organization, render custom UI decoration to emphasize particular fields or affordances, and the like.

Thereafter, once the third-party application instance 214 receives input, it can communicate that input to an associated backend, such as the third-party application backend 224.

These foregoing embodiments depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

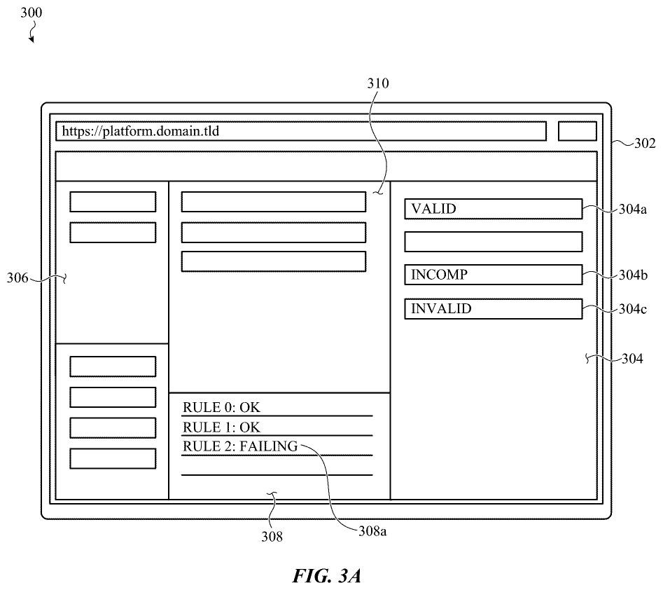

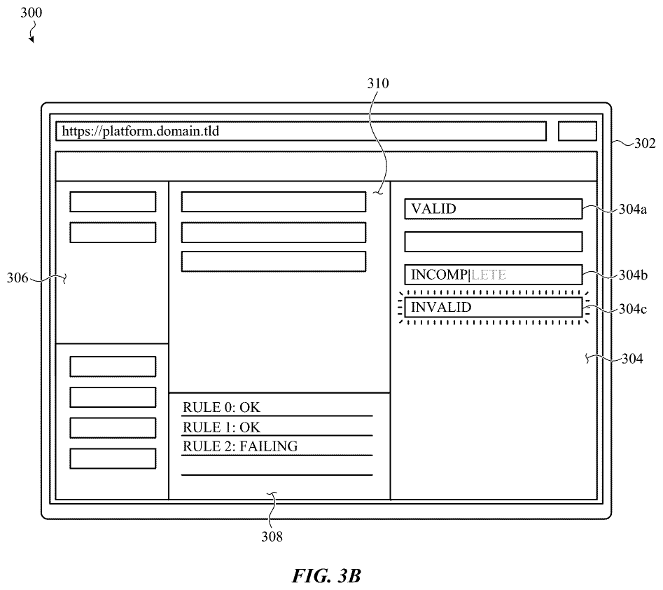

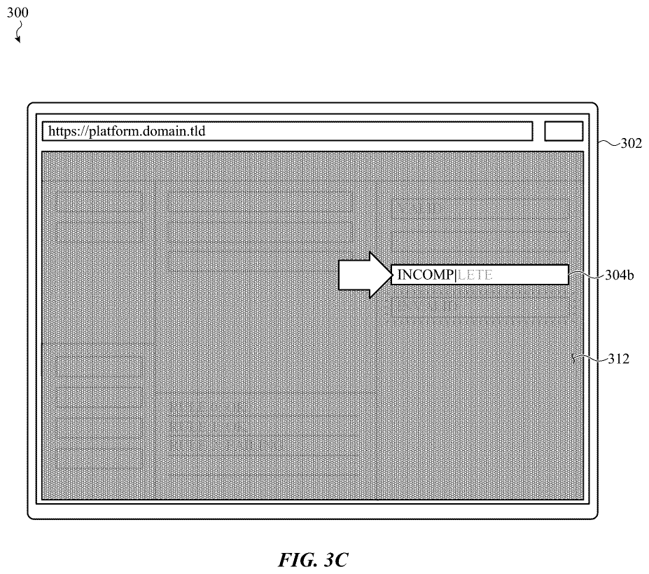

For example, as noted above, user interfaces can be modified or decorated in a number of ways. FIGS. 3A-3C each depict an example frontend application interface of a third-party software platform. As shown in FIG. 3A, the client device 300 includes a display 302 configured to render a graphical user interface 304. The graphical user interface 304 can be associated with a frontend application of a third-party data platform, as described herein. The graphical user interface 304 may include several user interface sections or regions, such as the graphical user interface section 306 which can include affordances for receiving user input. In some embodiments, the graphical user interface 304 can also include a section dedicated to rules or validation built in to the third-party software platform, such as the rule evaluation section 308 showing in real time one or more rules and whether those rules pass or fail. As an example, a rule evaluation result affordance 308a depicts information that the associated rule has failed.

The graphical user interface 304 can also include affordances to convey information to a user, such as the affordances 310.

As with many embodiments described herein, a user of the client device 300 can provide input to one or more text input box affordances, such as the text input box 304a, 304b, and 304c. In this example, the text input box 304a may include input from a user that successfully validates against a rule of the third-party software platform. The text input box 304b may include partial input, and the text input box 304c may include invalid input that does not validate against a rule of the third-party software platform. The third user input may prevent the third-party software system from submitting data to a backend system. In conventional systems, a user of the client device 300 may be required to winnow through an innumerable and potentially hidden or not readily findable affordances to determine which user input has caused a failure.

In other cases, the third user input may be accepted by the third-party software platform, but may be rejected by a downstream system as improperly formatted or otherwise invalid.

To help the user navigate the user interface of the third-party platform, embodiments described herein include a local interface management service configured to render additional information and/or decoration on the display 302. For example, FIG. 3B depicts a result of a local interface management service determining that the text input box 304c should be emphasized. Similarly, the local interface management service can determine that input provided to the text input box 304b is incomplete. In this example, the local interface management service can provide an in-line suggestion to the user of the client device 300 to complete the user input provided to the text input box 304b.

The local interface management service can operate with the frontend of the third-party software system or, in other cases, may render a graphical user interface layer over and/or separate from the user interface of the third-party software system. For example, FIG. 3C depicts a local interface management service rendering a masking layer 312 over substantially the entire user interface of the third-party software system so as to visually emphasize the text input box 304b. FIG. 3C also depicts an arrow-shaped sprite rendered to further emphasize the text input box 304b.

These foregoing embodiments depicted in FIGS. 3A-3C and the various alternatives thereof and variations thereto are presented, generally, for purposes of explanation, and to facilitate an understanding of various configurations and constructions of a user interface that can be modified by or masked by or layered over as a result of operation of a local interface management system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

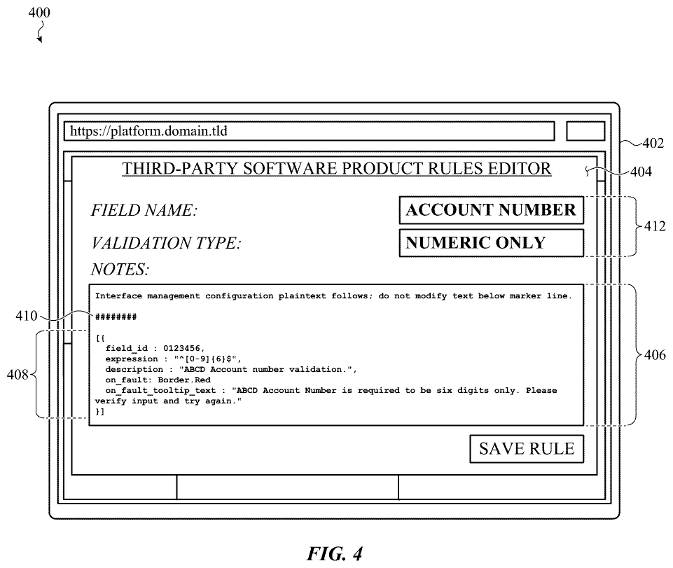

For example, as noted above, a local interface management service or system as described herein can store configuration objects that define its operation in a number of suitable ways. As noted above, some implementations of a local interface management service store data in a database of a client device. In other cases, a local interface management service can store one or more configuration objects within a third-party software tool itself. For example, FIG. 4 depicts an example user interface of a third-party data input application instance operating in conjunction with a local interface management service as described herein in which the local interface management service configuration is stored by the third-party data input application itself. Specifically, the client device 400 includes a display 402 that renders a graphical user interface 404. The graphical user interface 404 can be operated by a user to render a modal window to receive free-form user input, such as a window that defines a validation rule to be executed by the third-party data input application. In the example data validation/rule editor modal window, a text input affordance 406 can be provided to receive one or more user comments or free form text input. In this example, a local interface management service can insert a structured object 408 that represents a configuration object as described herein as plain text, optionally delineated by a marker 410. The text input affordance 406 can be optionally rendered in conjunction with other affordances 412.

In these embodiments, a local interface management service instance can be configured to load the text content from the third-party data input system, parse that content based on the marker 410, and operate in accordance with the configuration object stored therein.

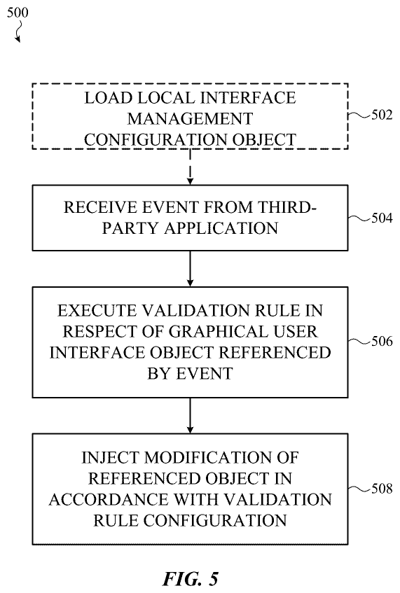

FIG. 5 is a flowchart depicting example operations of a method of operating a local interface management service as described herein. The method 500 includes operation 502 at which one or more configuration objects may be optionally loaded from memory, either separate from or associated with a third-party data entry system or application as described herein. Next at operation 504, an event associated with a user input to the graphical user interface of the third-party application can be received. Next at operation 506, one or more actions can be taken in response to the user input event and based on the configuration object. As an example, a validation rule defined by the configuration object can be executed against content of an affordance associated with the user input event. Next, at operation 508, a modification of the user interface of the third-party application can be injected so as to visually emphasize one or more affordances in the user interface, the one or more affordances referenced by or determined based on the configuration object.

These foregoing embodiments depicted in FIGS. 4-5 and the various alternatives thereof and variations thereto are presented, generally, for purposes of explanation, and to facilitate an understanding of various configurations and constructions of a user interface and methods for rendering the same by operation of a local interface management system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

As used herein, the term “processing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Similarly, the term “memory” refers to any software and/or hardware-implemented data storage device or circuit physically and/or structurally configured store digital information. This term is meant to encompass a single memory cell or unit, multiple memory blocks and systems, analog or digital circuits, or other suitably configured data or information storage element or combination of elements.

Example processing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Further, the foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on.

The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel.

In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

What is claimed is:

1. A computer-implemented method for modifying a local graphical user interface of a front-end application running within an operating environment of a client device, the method comprising:
instantiating, within the client device operating environment, a local interface management service configured to modify the local graphical user interface;
executing, by the local interface management service and for each respective configuration object of a set of configuration objects, a callback sequence comprising:
accessing, by the local interface management service, a set of configuration rules of the respective configuration object;
receiving a set of field data corresponding to one or more population rules of the set of configuration rules;
determining, for each field datum of the set of field data and using the one or more population rules, a respective set of population targets;
populating each respective set of population targets with the corresponding field datum;
computing, for each field datum of the set of field data and using one or more validity rules of the set of configuration rules, a respective field datum validity; and
rendering one or more validity indicators in a user interface layer above the front-end application, each validity indicator corresponding to a respective field datum validity.

2. The computer-implemented method of claim 1, wherein at least one callback sequence is executed in response to a hook event of the front-end application.

3. The computer-implemented method of claim 2, wherein the hook event of the front-end application corresponds to a change in a text content of a text input box.

4. The computer-implemented method of claim 1, wherein the one or more validity indicators are rendered proximate to an input field corresponding to the respective field datum.

5. The computer-implemented method of claim 1, wherein the local interface management service is configured to directly insert one or more UI decorations into the local graphical user interface of the front-end application.

6. The computer-implemented method of claim 1, wherein the local interface management service is configured to store a structured data object defining one or more configuration objects of the set of configuration objects.

7. The computer-implemented method of claim 1, wherein the structured data object is stored as plain text within the front-end application.

8. A system for modifying a local graphical user interface of a front-end application running within an operating environment of a client device, the system comprising:
a local interface management service configured to modify the local graphical user interface, the local interface management service executing on a client device having a processing unit and a computer readable memory storing instructions for:
instantiating, within the client device operating environment, a local interface management service configured to modify the local graphical user interface;
accessing, by the local interface management service, a configuration object including a set of rules corresponding to one or more affordances of the local graphical user interface;
receiving a set of field affordance inputs corresponding to the one or more affordances and one or more population rules of the set of rules;
determining, for each field affordance input of the set of field affordance inputs and using the one or more population rules, a respective set of affordances to be populated;
populating each respective set of affordances to be populated with the corresponding field affordance input;
computing, for each field affordance input of the set of field affordance inputs and using one or more validity rules of the set of rules, a respective field affordance input validity; and
causing display of one or more validity decorations in a user interface layer above the front-end application, each validity decoration corresponding to a respective field affordance input validity.

9. The system of claim 8, wherein the callback sequence is executed in accordance with a determination that a hook event of the front-end application has occurred.

10. The system of claim 9, wherein the hook event of the front-end application corresponds to a change in a field affordance input.

11. The system of claim 8, wherein the one or more validity decorations each comprise at least a border, an underline, or an animation of a sprite.

12. The system of claim 8, wherein the local interface management service is configured to inject one or more additional decorations into the local graphical user interface of the front-end application.

13. The system of claim 8, wherein the local interface management service is configured to store a structured data object defining the configuration object.

14. The system of claim 13, wherein the structured data object is stored as plain text within the front-end application.

15. A computer-implemented method for modifying a local graphical user interface of a front-end application running within an operating environment of a client device, the method comprising:
instantiating, within the client device operating environment, a local interface management service configured to modify the local graphical user interface;
executing, by the local interface management service and for each respective configuration object of a set of configuration objects, a callback sequence comprising:
accessing, by the local interface management service, a set of configuration rules of the respective configuration object;
receiving a set of nonce inputs corresponding to one or more population rules of the set of configuration rules;
determining, for each nonce input of the set of nonce inputs and using the one or more population rules, a respective set of population targets;
populating each respective set of population targets with the corresponding nonce input;
receiving a set of format-sensitive inputs corresponding to one or more format validation rules of the set of configuration rules;
computing, for each format-sensitive input of the set of format-sensitive inputs and using the one or more format validation rules of the set of configuration rules, a respective format validity; and
rendering one or more format validity indicators in a user interface layer above the front-end application, each format validity indicator corresponding to a respective format validity.

16. The computer-implemented method of claim 15, wherein at least one respective callback sequence is further comprises initiating a notification via a notification channel.

17. The computer-implemented method of claim 15, wherein each configuration object of the set of configuration objects are stored as either an XML or JSON formatted string.

18. The computer-implemented method of claim 15, wherein the callback sequence is executed in accordance with a determination that a hook event of the front-end application has occurred.

19. The computer-implemented method of claim 16, wherein the hook event of the front-end application corresponds to a change in at least one format-sensitive input.

20. The computer-implemented method of claim 15, wherein the one or more validity indicators each comprise at least a border, an underline, or an animation of a sprite.
